(19) United States
(12) Patent Application Publication
(10) Pub. No.: US 2012/0041844 A1
(43) Pub. Date: Feb. 16, 2012

(54) ELASTIC LICENSING OF SOFTWARE IN A CLOUD ENVIRONMENT

(75) Inventors: Jianjun SHEN, Beijing (CN); Ying HE, Palo Alto, CA (US)

(73) Assignee: VMWARE, INC., Palo Alto, CA (US)

(21) Appl. No.: 13/197,577

(22) Filed: Aug. 3, 2011

(30) Foreign Application Priority Data
Aug. 12, 2010 (CN) 201010251879.9

(51) Int. Cl. G06Q 30/00

(52) U.S. Cl. 705/26.61

(57) ABSTRACT

In one aspect, a method includes publishing an object of a user such that another user can search for the object by means of a user interface. The object may be an application, an application group, an application component, and/or a service. The object runs on a platform. The platform may be a hypervisor, an application container, a mobile platform, and/or a computer. The method includes permitting another user to access the object based on a transacting for the object between the users. The transaction may involve a clone transaction, a grant transaction, an application component transaction or a service transaction. A tax may be levied based on the transaction. A scope of the access of the object to another user is based on a transaction protocol, which is based on the transacting between the users. The transaction protocol may include a payment scheme, a term, or a set of object rights.

### FIELD OF TECHNOLOGY

This disclosure relates generally to software licensing, virtual machines, cloud computing and, in one example embodiment, to a method and system for software licensing and transaction in a cloud environment.

### BACKGROUND

Software may be copyright protected. A software license may be a legal instrument governing the usage and/or redistribution of software. The software license may grant an end-user permission to use one or more copies of the software. The software license may be necessary to avoid copyright infringement of the software for usage of the software.

Some users may use the software without the software license and/or may make unauthorized copies of the software. Such a usage may be software piracy. Software piracy may have a negative impact on the software industry, because software piracy may reduce revenue a software company receives from a sale of software licenses associated with the software.

Additionally, individual software developers may not have the resources to publish and/or distribute software that they develop. A lack of such resources may create barriers for individual software developers to enter the marketplace. As a result, individual software developers may be discouraged from developing new software, causing a decrease in overall software development.

### SUMMARY

In one aspect, a method of a server device includes publishing an object of a user such that another user can search the object through a user interface. Examples of the object may be an application, an application group, an application component, and a service. The object may be stored and run on a platform. Examples of the platform may be a hypervisor, an application container, a mobile platform, and/or a computer comprising a trusted operating system.

The method includes permitting another user to access the object based on a transaction of the object between the user and another user. Examples of the transaction involving an application and/or an application group include a clone transaction and a grant transaction. Other transactions may include an application component transaction and a service transaction. A tax may be levied based on the transaction. A scope of the access of the object to another user is based on a transaction protocol. The transaction protocol is based on the transaction of the object between the user and another user. The transaction protocol may include a payment scheme, a term, and a set of object rights.

A transaction protocol may be coupled to the object such that the object comprising the transaction protocol may be controllable based on the transaction protocol. Users may be prevented from modifying the transaction protocol coupled with the object. The transaction protocol coupled with the object may be copied when a copy of the object is made.

A sum of money to collect from another user is determined based on a payment scheme. The payment scheme may be based on the transaction protocol. Examples of the payment scheme include a fixed price payment scheme, an object copy payment scheme, an object usage payment scheme, and an object owning time payment scheme. The access of the object may be monitored such that scope of the access of the object may be restricted. The scope of the access may be based on the transaction protocol. The management of the access of the object may reduce a piracy of the object.

The method may further include permitting a user to modify the application or application group. A user may be permitted to create a copy the application or application group. A user may be prevented from participating in the transaction based on a limitation that restricts a participation based on a certification.

The transaction may be validated based on a verification of the transaction protocol. An object operation may be monitored and controlled such that the object operation is in compliance with the transaction protocol. The lifecycle of an object may be managed based on the transaction protocol.

The payment scheme may be based on a tiered distribution model. The distribution model may include users that are distributors of the object. The distributors may distribute the object to other users such that a distributor that distributes the object or a copy of the object to another user shares in the profits of the sale of the object and its copies.

A right to use and access the object may be enforced based on the transaction protocol. The right may be enforced through an operating system of a guest. The operating system of the guest may be aware of the cloud environment. The right may be enforced through the hypervisor. The right may be enforced by the object itself, where the object is aware of the cloud environment.

The lifecycle start of an object may be monitored and the transaction protocol may be coupled to the object. The lifecycle termination of an object may be monitored and the transaction may be settled. An account may be kept of the object owning time and the object usage. For example, the object owning time and the object usage may be recorded and counted such the payment is calculated based on the object owning time and the object usage. A transaction term expiration of the object may be monitored. Corresponding actions based on the transaction protocol of the object may be triggered. A cloning history of the application and the application group object may be maintained. The billing and tax procedure may be started at a billing point.

The object may be delivered to the buyer after a transaction. An illegal object copying may be prevented. A payment based on the transaction protocol of the object may be dynamically calculating. The payment based on the transaction protocol of the object may be collected. A transaction tax may be levied on the seller.

The object may be ranked. The ranking of the object may be based on a credit and a referral of a publisher, a frequency and a number of the transactions for the object, a total number of copies made, a total time the object is in use, an average time an object copy is in use, a cost to use the object including a payment and a resource usage cost, a rating by users that have used the object, and results of an object specific evaluation.

In another aspect, the method may include permitting a user to publish an object such that another user can search the object through a user interface. The other user may be permitted to access the object based on a transaction of the object between the user and the other user. A scope of the access of the object to the other user may be based on a transaction protocol. The transaction protocol may be based on the transaction of the object between the user and the other user.

A sum of money to collect from the other user may be based on a payment scheme. The payment scheme may be based on the transaction protocol. The access of the object by the other user may be monitored such that the scope of the access of the object may be restricted based on the transaction protocol. A distribution of the object may be facilitated such that the object of the user may be available to another user through one or more platforms.

In one aspect, a system may include an object. The system may also include a platform to run and store the object, a processor to process a transaction of the object, a transaction protocol to determine a scope of access of the object, and a payment scheme based on the transaction protocol to determine a sum of money to collect through the transaction.

The method, system, and apparatus disclosed herein may be implemented in any means for achieving various aspects, and may be executed in a form of a machine-readable medium embodying a set of instructions that, when executed by a machine, may cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIGS. 1A-1C illustrates an example scenario of operation of the system, according to one or more embodiments.

FIG. 2 is a schematic view of operation flow within the management architecture of cloud of FIG. 1, according to one or more embodiments.

FIG. 3 is a schematic view of a cloud infrastructure of a cloud environment, according to one or more embodiments.

FIG. 4 is a schematic view of a user interface of a client device of the cloud environment of FIG. 1, according to one or more embodiments.

FIG. 5 is a path flow diagram illustrating the operations of the client device in the system of FIG. 1, according to one or more embodiments.

FIG. 6 is a schematic view of a client device in the cloud environment, in accordance with one or more embodiments.

### DETAILED DESCRIPTION

A method, apparatus, and/or system of software licensing and transaction in a cloud environment are disclosed. Although specific example embodiments will be described and illustrated, it will be evident that various modifications and changes may be made to these embodiments without departing from the broader spirit and scope of the disclosed method and system.

The different types of software (they may be referred to as “objects” herein) that may be involved in a transaction, include but are not limited to, an application, an application group, an application component, and a service. An application may be software implementation of a machine, for example a computer, which executes programs similar to a physical machine. An example of an application may be a virtual machine. An application group may comprise more than one application and/or another application group. The application group may be the parent group (parent object) and an application included within the parent application group may be a child application (child object). The application group included within the parent application group (parent object) may be the child application group (child object). An application may include one or more application components. An application component (child object) may be installed to an application (parent object). A service may provide some services for an application and/or an application group. Additionally, an application or application group (parent object) may subscribe to a service (child object).

An application may be stored and run on a platform. A platform may include a hardware architecture and/or a software framework (including application frameworks), that allows a software program to run. Examples of platform may include a hypervisor, an application container (e.g. Java Virtual Machine or Web container), a mobile platform (e.g. mobile phone), a computer (with a trusted OS, OS enhancement, and/or trusted hardware).

A platform may be provided through a cloud environment by a cloud operator. A cloud environment may be an Internet-based computing environment, whereby shared resources, software and/or information are provided to computers and other devices on-demand. Examples may include Platform-as-a-Service (PaaS) cloud environment and Infrastructure-as-a-Service (IaaS) cloud environment. Additionally, a platform may be owned by an end user; however the end user may not be able to interfere with the enforcement of the disclosed software licensing and transaction model. Examples of platforms that may be owned by an end user include a mobile platform, a trusted hypervisor, a trusted application container, and a trusted computer. The enforcement of the software licensing agreement may be maintained through the platform. One or more platforms may be utilized to implement the disclosed software licensing and transaction model.

Examples of IaaS clouds (and implementations) include Amazon EC2 and VMware vCloud (1.0). Examples of PaaS clouds include Google App Engine and Microsoft Azure.

Examples of the application include a virtual machine. A virtual machine may run on a hypervisor. The application may run in a container. Examples of an application that runs in a container include a Java application in a Java Virtual Machine and a Web application in Web container. Examples of application component include a guest OS and an application software that is installed and runs in a VM.

An application or an application group may be accessible and/or owned by a user. In one embodiment, a user is able to modify an application by adding/removing components, by adding/removing a subscribed service, and/or by modifying the configuration and/or settings of the application. A user may be able to modify an application group by adding/removing/modifying child applications or child application groups, by adding/removing a subscribed service, or by modifying the configuration or settings of the application group. A user may be able to create a new application, an application group, an application component, and/or service.

A user may be able to make a copy (clone) of an application or application group, and/or transfer an application or application group to another user or from one platform to another platform. When an application is cloned or transferred, the states of the application (for example, data, configuration, installed components, and subscribed services) may be copied or transferred with the application. When an application group is cloned or transferred, the states of the application group (for example, configuration, child applications, child application groups, and subscribed services) may be cloned or transferred with the application group.

A user may be able to take a snapshot of an application or application group. A snapshot can include the states of the application or application group when the snapshot is taken. An application or application group may be restored to one of the previous snapshots of the application or application group. The states recorded in the snapshot may be restored.

A transaction can be a procedure through which a user (for example, a seller) distributes an object (for example, a software program) to another user (for example, a buyer). In a transaction involving an application or an application group, the seller may clone or grant the application or application group to the buyer. In a clone transaction, a new copy of the application or application group may be transferred to the buyer. In a grant transaction, the application or application group itself may be transferred to the buyer and the seller may lose an ownership of the application or application group.

In an application component transaction, the seller may sell the application component to an application of the buyer. The component may be installed or may be allowed to be installed into the target application of the buyer. In a service transaction, the seller (for example, a service provider) may sell the service to an application or application group of the buyer, and the service may be subscribed and/or may be allowed to be subscribed by the target application or application group of the buyer after the transaction.

A transaction protocol may be based on a transaction between the seller and the buyer. A transaction protocol may include a payment schema, a term, and/or a set of rights relevant to the use of the object. After an object transaction, the transaction protocol may be coupled to the object.

A transaction protocol may have a term defined by a period of time in which another user owns and/or has access to the object, or defined by amount of time that another user can use and/or run the object. For example, in the context of a grant transaction involving an application or application group, when the term expires, use of the application or application group may be revoked and the application or application group may be returned back to the seller. When the application or application group is returned back to the seller, the application or application group may be restored to a snapshot taken when it is sold. In the context of a clone transaction, a copy of an application or application group sold to the buyer may be automatically removed and/or rendered unusable when the term expires. For example, in transactions involving an application component and/or service, the application component and/or service sold to the buyer may be removed or rendered unusable when the term expires.

A transaction protocol might include a set of rights to the object acquired by the buyer through the transaction. Examples of object rights include the number of copies of the object the buyer is permitted to create, rights to modify and/or access the object, rights to redistribute or sell the object to other users, and rights to change a payment scheme of the object in a redistribution transaction.

When a user makes a new copy of an object that is coupled with a transaction protocol, the remaining transaction term and rights of that object may be fixed based on the transaction protocol. When the buyer redistributes the object to another user, the buyer may shorten the length of the term and/or may reduce the rights the buyer has to the object, but the buyer may be prevented from augmenting the rights the buyer has to the object.

When a user clones an application or application group (e.g., clones the application or application group for the user's own use), or sells an application or application group through a clone or grant transaction to another user, child (descendant) objects (for example, installed application components, subscribed services, child applications and/or application groups) may be copied, or may be included in the transaction with the application or application group. A child object may originally be coupled with another transaction protocol. The another transaction protocol of the child object may continue to be enforced on the new copy of the child object or the sold child object after the application or application group cloning and/or transaction.

A child object may be coupled with another transaction protocol. The transaction protocol of the child object may be independent of the transaction of the parent object. For example, a user might buy an application component based on a transaction protocol. The application component may be installed to an application of the user. When the user sells the application (parent object) with the application component (child object) to another user, the transaction protocol of the application and the other transaction protocol coupled with the application component may continue to be enforceable.

A payment scheme may be based on the transaction protocol. The payment scheme may include one or multiple payment modes. Those modes may include a fixed payment, a payment based on the number of object copies, a payment based on the usage of the object, or a payment based on the amount of time the object is owned. A fixed payment may be a fixed sum of money the buyer may pay to the seller through a transaction.

A payment based on an object copy number may be calculated based on the number of copies of the object the seller creates. A copy of a child object may be counted with the copy of the parent (ancestor) object. For example, a child object is bound with a copy number involved payment scheme (that is, the payment schema of the transaction protocol coupled with the child object includes a payment mode based on number of object copies). When the parent object is copied, the child object may be copied as well with the parent object. When a user copies a parent object that comprises a child object bound with a copy number involved payment scheme, the user may be charged for the copying of the parent object and also be charged for the copying of the child object. The user may be charged for the copying of the child object based on the payment scheme bound with the child object. For example, when an application group is cloned, the child applications, application groups, application components installed on the child applications, and the services subscribed by the application group, child applications and application groups may be copied as well with the clone of the application group.

A payment based on a usage of the object may be calculated according to the amount of time and/or frequency the buyer uses the object. For example, a user who uses an object more pays more. For example, an application or application group usage is calculated based on the application running time (e.g. VM powered-on time). An application component usage may be calculated based on component loading (e.g. executing of guest OS or software in a VM) time. A service usage may be calculated based on the working or servicing time of the service.

Object owning time based payment may be calculated according to the amount of time the buyer owns the object. For example, the user can stop paying by removing the object and/or in an application or application group grant transaction by returning the object back to the seller. For example, an application component owning time may be counted by how much time the component is installed in the buyer's application. A service owning time may be calculated by how much time the service is subscribed by the buyer's application or application group.

When a user makes a copy of an object that is coupled with a transaction protocol and/or redistributes the object to another user, the payment scheme in the original transaction protocol may continue to take effect on the new copy of the object or the redistributed object. For example, an application may be bound with a copy number involved payment scheme. When the application is redistributed to another user and/or each time the new user clones the application, the new user pays the original seller based on the payment scheme's definition. And if a child object is coupled with a transaction protocol, its payment scheme continues to take effect when the child object is copied or is redistributed to another user with the parent object. For example, a service subscribed by an application group may be bound with a usage involved payment scheme. When the user clones the application group, the new service copy (in the new application group clone) may still be bound with the original payment schema. The user may pay for the usage of the new service copy based on the payment scheme's definition.

When a user redistributes an object to another user, the user may be able to extend the payment scheme of the original transaction protocol coupled with the object, if an extension is permitted by the object rights definition of the original transaction protocol. The extension requires an extra payment from the next buyer. The initial payment to the original seller as defined in the original transaction protocol may be protected. Allowing a payment scheme extension encourages a user to improve and/or propagate objects that are owned by the user.

The payment scheme may be based on a tiered distribution model. When a new object copy is created and/or is redistributed to a new user, a distributor in the distribution tree and/or distribution chain is able to share profits. The payment scheme may define a percentage of profits that each distribution level shares.

In one example, the originator (e.g. vender) may sell an object to a first level distributor. The first level distributor then may redistribute a copy of the object to a second level distributor. When the second level distributor creates a new copy of the object, the first level distributor may be able to draw a percentage of the payment from the second level distributor. When the second level distributor redistributes an object copy to another user, the originator, the first level distributor and/or second level distributor may share the payment from the new user.

A tax may be levied for each transaction. Payment and/or transaction tax may be automatically calculated. The payment and/or transaction tax may be dynamically calculated in runtime. The buyer may be billed at billing points. The seller and/or a distributor may be paid. The transaction tax may be levied when the seller is paid and/or when the buyer is billed.

In an embodiment, the system may prevent a user from participating in a transaction. The system may permit a subset of registered users to participate in a transaction. A subset of certified venders and/or the operator of the platform may be permitted to distribute objects to users.

In an embodiment, the system may provide an interface for a user to publish an object to be a product. A user optionally submits a set of predefined transaction protocols at product registration. After registration, the product is searched from a searching interface, which allows a user to search products with various conditions (e.g. payment, and other object characteristics). A seller may also be able to advertise and/or sell an object to a specific buyer privately when the object is not published.

A buyer may start a transaction of an object (may be a registered product the buyer found through a product search and/or an object the buyer learns through a different method) through a trading interface. The buyer may also be permitted to negotiate with the seller on the transaction protocol.

Before the completion of a transaction, the system may validate the transaction protocol of the transaction. The system checks and/or verifies that the transaction protocol is compatible with respect to object rights, term, and payment scheme to existing transaction protocols coupled with the object and its child/descendant objects.

After the completion of the transaction, the object or a copy of the object may be delivered to the buyer. The transaction protocol may be coupled to the object. The user may be prevented from changing the transaction protocol coupled with an object. The delivery of the object or object copy (for example, the transfer or clone of an application or application group, installation of an application component, or subscription of a service) may be done though controlled interfaces such that illegal object copies may be prevented.

In a grant transaction of an application or application group, if the transaction protocol includes a transaction term definition, a snapshot of the application or application group may be taken. The application or application group may be restored when the application or application group is returned back to the seller at transaction term expiration.

The system may enforce the object rights defined in a transaction protocol. The system monitors and/or controls user operations on an object. Examples of object operations include a cloning or configuration of an application or application group, a running or stopping of an application, an installing or uninstalling of an application component, a loading or unloading of an application component, a subscribing or unsubscribing of a service, a starting or stopping of a service, and a modification of an object. For example, when an application or application group is cloned, the transaction protocols that are coupled with the application or application group or the child objects of the application or application group may be checked to validate the cloning operation. If the cloning operation is not allowed by any transaction protocol (e.g. the operation conflicts with the right of object copies), the operation may be aborted.

The lifecycle of a managed object may be monitored and/or tracked. A managed object may be an object coupled with a transaction protocol.

The transaction protocol may be coupled to the object after a transaction and/or object delivery. The object lifecycle may be monitored. The monitoring may commence with a transaction or a new object copy. The copying of an object and/or the transaction of an object may initiate the lifecycle monitoring of the object. The billing and/or tax procedure may be started at the initiation of the lifecycle monitoring of the object.

The transaction term expiration may be monitored. The corresponding actions are taken at term expiration. Examples of actions that may be taken at term expiration include a removal and/or destruction of the object, a limitation on the accessibility and/or usability of the object by the user, and a return of the object back to the seller in a situation involving an application or application group in a grant transaction.

The termination of the object lifecycle may be monitored. Examples of object lifecycle termination include a transaction term expiration, an object destruction/removal, a returning back to the seller, a transfer to another user. The transaction may be settled if the object is coupled with a transaction protocol, and the billing and/or tax procedure may be started.

Accounts of the object existence time may be recorded. Accounts may be recorded if the transaction protocol includes a payment scheme involving an object owning time. The billing and/or tax procedure may be started at a billing point at which the amount of object owning time accumulates to a threshold from the previous billing point.

Accounts of object (application and application group) running, (application component) loading, and/or (service) serving time may be recorded. Accounts may be recorded if the transaction protocol includes a payment scheme involving an object usage. The billing and/or tax procedure may be started at billing point at which the amount of time that the object is in use accumulates to a threshold from the previous billing point.

In one or more embodiments, a ranking mechanism may be included. All published objects are given some rating points based on the credit and referral of its publisher, frequency and number of transactions for the object, total number of copies made in the system, total time the object is in use, average time the object and its copies are in use, a cost to use the object including payment and a resource usage cost, rating by users have used the object. An object may gain extra points in object specific evaluations, and the like.

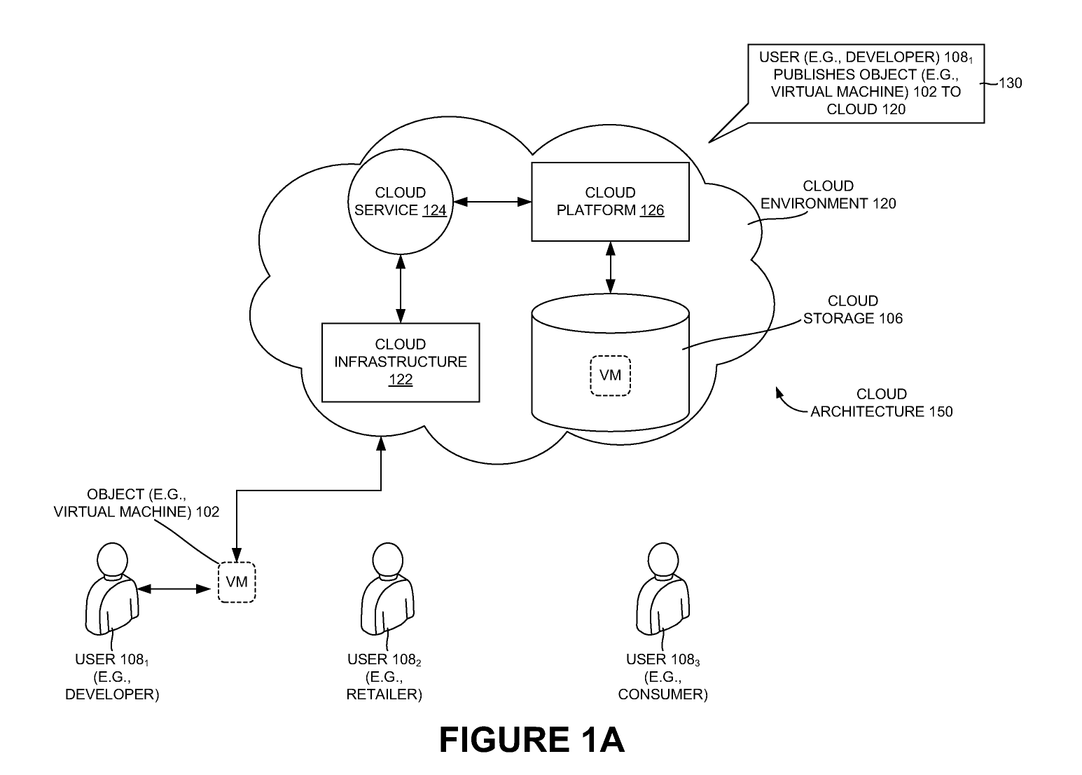

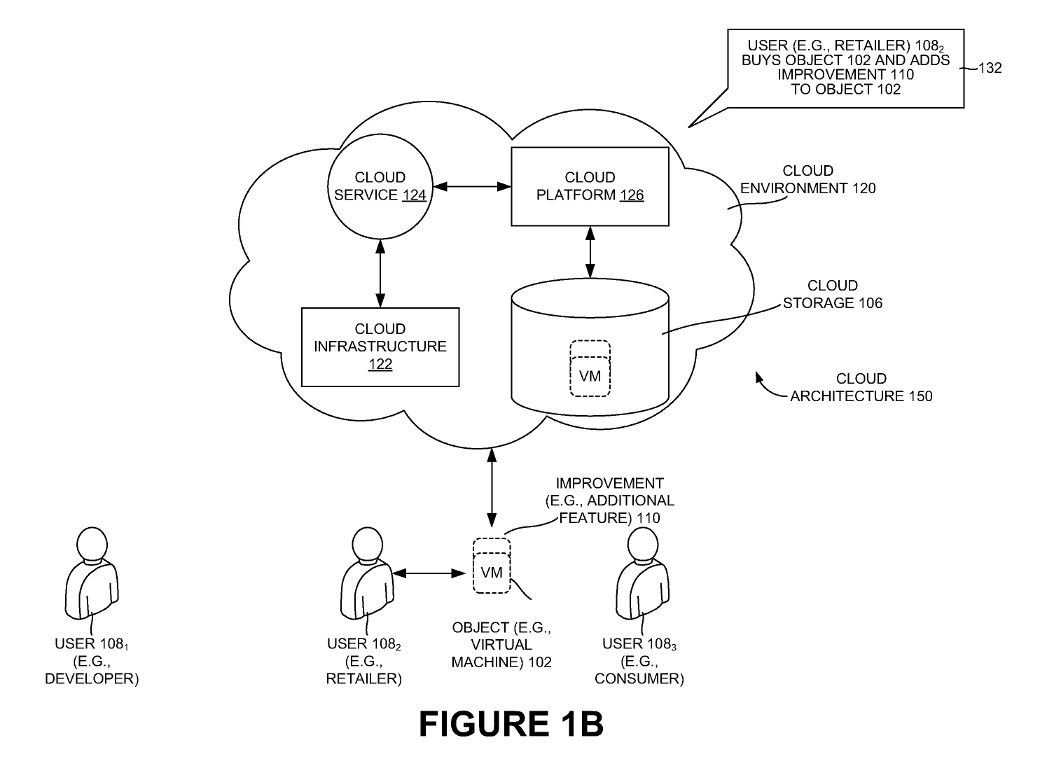

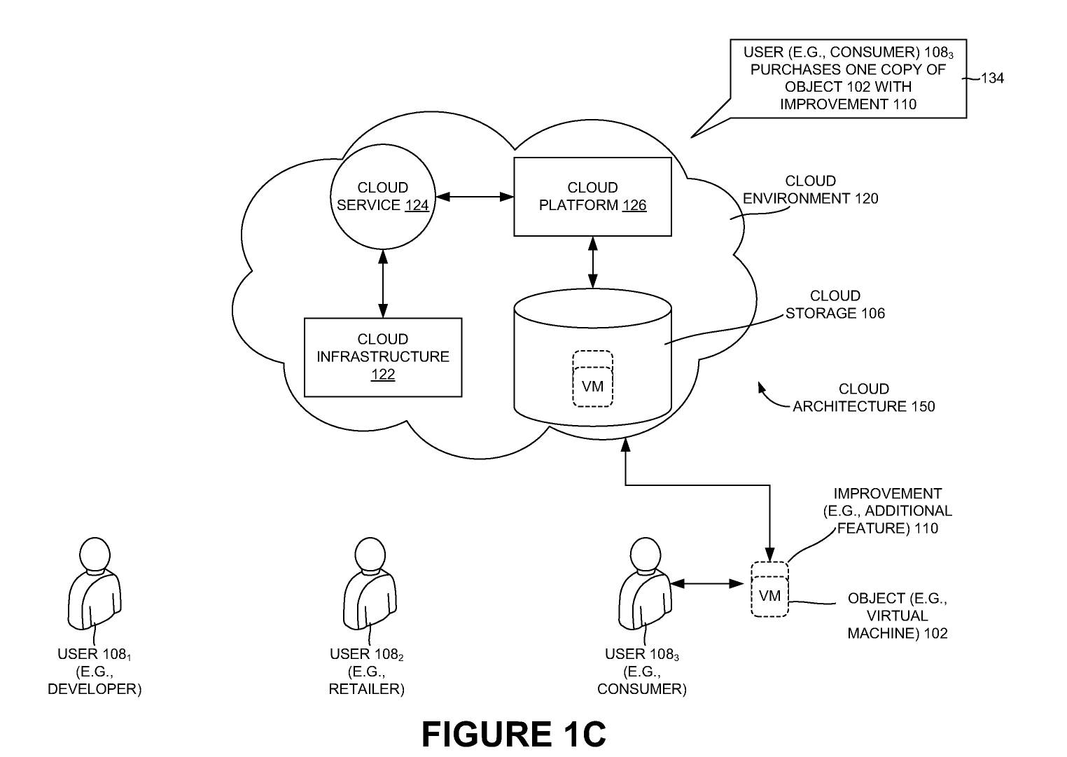

FIGS. 1A-1C illustrate an example scenario of the system in an IaaS cloud, according to one or more embodiments. In one or more embodiments, the system includes a cloud environment 120. The cloud environment 120 may include a cloud infrastructure 122, a cloud service 124, a cloud platform 126, and a cloud storage 106. The cloud infrastructure may include one or more modules configured to control and coordinate various services provided by the cloud platform 126 through the cloud service 124. The cloud storage 106 may function as a repository for data associated with applications and/or application groups, transactions in the cloud environment 120 and cloud services provided by the cloud architecture 150. In one or more embodiments, the cloud platform may comprise one or more hypervisors on which applications (VMs) run. In one or more embodiments, in operation 130, a user (e.g., a developer) 108₁ publishes an object (e.g., a VM) 102 in the cloud environment 120. In operation 132, another user (e.g., a retailer) 108₂ buys the object 102 and adds improvement 110 to the object 102. The improvement may be, for example, an additional feature. In operation 134, a third user (e.g., a consumer) 108₃ purchases one copy of the object 102 with improvement 110. The third user 108₃ may be charged for purchasing the copy of the object 102 by the developer 108₁ and a share of the profit from the sale may be given to the retailer 108₂ as well.

The object (for example, the application or application group) may be already in the cloud before publication. Publication may be registering the object to be a product such that the object is visible to another user through a product search function. Before and after a transaction, the object may be stored in the cloud. After the transaction, the ownership of the object may change.

In the example embodiment, the roles of the users are provided as examples. Each user may have multiple roles. The role of the user may be more than a developer, retailer, and/or consumer. The consumer and/or retailer may redistribute the object to another consumer. In some embodiments, the roles of the users are restricted based on a certification of the user.

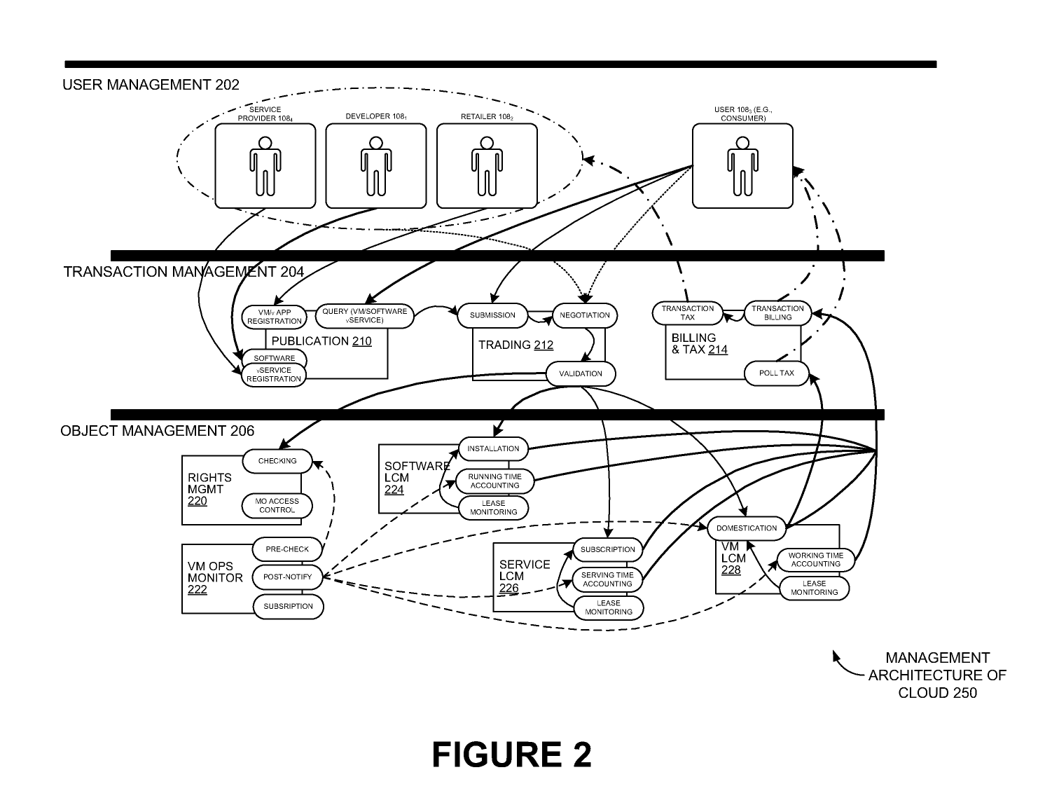

FIG. 2 is a schematic view of operation flow within management architecture of cloud 250 (cloud architecture 150 of FIG. 1A), according to one or more embodiments. The management architecture of cloud 250 includes a user management system 202, a transaction management system 204, and an object management system 206. The transaction management system includes a publication system 210, a trading system 212, and a billing and tax system 214. The object management system 206 may include one or more of a rights management system 220, a VM operations (OPS) monitor system 222, a software LifeCycle Management (LCM) system 224, a service LCM system 226, and a VM LCM system 228. FIG. 2 further illustrates various services in a cloud environment 120 disclosed herein.

In an IaaS cloud embodiment, an application may be a VM, an application group may be a VM group, an application component may be a guest software program that runs in a VM including a guest OS and application software, a service may be for (subscribed by) a VM or VM group. A guest may be a virtual machine running an operating system supported by the underlying hardware.

An IaaS cloud may comprise one or more hypervisors. A VM may run on a hypervisor. Examples of service may include a DHCP, load balancing, a firewall, a virus scan, a high availability service, etc. A service may be provided by a cloud user (for example, through the service provider's VMs and/or VM groups), or may be provided by the cloud operator. After a VM or VM group subscribes to a service, the VM or VM group may be able to use (be served by) the service based on the service transaction protocol.

A term of a VM or VM group transaction may be defined by amount of time a user owns the VM or VM group and/or an amount of time a user can power-on the VM or VM group. A term of a software transaction may be defined by an amount of time the software may be installed and/or an amount of time a user can run the software program. The term of a service transaction may be defined by an amount of time the service is subscribed and/or an amount of time the service serves the target VM or VM group.

Examples of rights shared by VM, VM group, software, service object may include the number of copies (with VM or VM group clones) of the object a user can make and rights to redistribute the object to another user. Examples of VM or VM group rights include rights to subscribe/unsubscribe to a service, rights to modify configurations. VM rights can also include rights to install/uninstall software and/or rights to execute specific programs in the VM. VM group rights may also include rights to add/remove child VMs and/or VM groups.

A VM or VM group may be also coupled with transaction information. For a VM, the transaction information may include a VM transaction protocol, the software transaction protocols for the managed software installed in the VM, and the service transaction protocols for the services subscribed by the VM. For a VM group, the transaction information can include a VM group transaction protocol and the service transaction protocols for the services subscribed by the VM group. VMs, VM groups, and/or software can be acquired based on a transaction protocol that may be coupled to the VMs, VM groups, and/or software. A VM, a VM group, or software that is coupled with a transaction protocol is called a managed VM, a managed VM group, or managed software respectively.

The transaction protocol bindings may be generated at managed VM or VM group lifecycle start, managed software installation, and service subscription. The transaction protocol bindings are updated at managed software installation/uninstallation, service subscription/unsubscription, and/or transaction term expiration.

The transaction protocol bindings may be stored with VM or VM group configurations and/or in a database. When a VM or VM group is exported to a VM or VM group template, its transaction protocol bindings may be exported in the template too. Transaction protocol bindings may be protected by the cloud such that the cloud limits access by users such that the transaction protocol bindings are protected from damage.

The system through a cloud environment may provide an interface for users (e.g., VM/VM group venders, solution integrators, distributors, software venders, and service providers) to publish their products. The publication system may open a registration service for a seller to register his products. A VM and/or a VM group product may be registered in the form of a VM or a VM group template, a VM or a VM group snapshot, and an existing VM or VM group. The publication system may provide a searching service for a user to query registered products and initiate transactions.

Users may establish transactions through a trading system. A buyer may start a transaction by submitting a transaction request on an object to the trading system. Depending on the seller's definition at product registration, the trading system may allow the buyer to initiate a negotiation with the seller on the transaction protocol.

The trading system may inspect the final transaction protocol. In a VM or VM group transaction, this protocol validation procedure may check the transaction protocol to ensure that the transaction protocol is compatible with any existing transaction protocol bindings (including the transaction protocols of the child objects) with the VM or VM group (and its child and descendant VMs and VM groups). In a software or service transaction, the validation procedure may check the transaction protocol to ensure that the transaction protocol is compatible with the existing transaction protocol bindings of the target VM or VM group. The transaction protocol validation may also involve checking object rights.

After the transaction protocol is validated, in a VM and/or a VM group transaction a VM and/or a VM group delivery request can be submitted to the VM LCM system, which delivers the VM and/or a VM group to the buyer. In a software transaction an installation request may be sent to the software LCM system, which installs the software to the target VM. In a service transaction, a service subscription request may be sent to the service LCM system, which subscribes to the service for the target VM or VM group.

A user may be billed by a transaction billing service at a transaction billing point. The billing procedure may be started by VM, software, and/or service LCM management systems. It also notifies a tax service to levy transaction tax on the seller. The billing service traces VM or VM group cloning histories to calculate payment and profit shares of each distribution level in a tiered distribution.

VM operation monitoring may be a mechanism that enables the cloud to supervise VM or VM group operations. VM or VM group operations and events that may be monitored may include cloning, creation and destruction, template exporting and importing, power operations, and configuration.

Other cloud services subscribe to notifications of specific operations and events from the VM OPS monitor system, and trigger different actions for one or more operations or events, and/or terminate an operation.

VM rights control may be for the implementation of a rights set definition of the transaction protocol. VM or VM group cloning, configuration, and power operations rights control may be triggered by notifications from the VM OPS monitor system. The notifications may be implemented based on the hypervisor.

Object redistribution rights may be checked during transaction protocol validation. Software installation/uninstallation and service subscription/unsubscription rights control may be performed by the software and service LCM systems.

The program execution right control of a VM can be enforced during runtime inside a guest. A software program may be cloud-aware such that the execution right is checked with the rights management system by the software program at startup. The software program may quit if the user does not have rights to run the software program. The guest OS may be cloud-aware, such that the execution rights to run a software program in the guest OS are checked with the rights management system, enforced, and controlled by the guest OS. Enforcement of program execution rights may be implemented leveraging virtualization technologies (e.g. VMSafe®), which may allow a hypervisor to control program execution inside a guest.

To support VM and VM group transaction, the cloud may track a lifecycle of a managed VM or a managed VM group. VM LCM system may monitor the lifecycle start of a managed VM or a managed VM group, generates transaction protocol bindings, and starts the billing and tax procedure if this is required by the transaction protocols (including the transaction protocols of the child objects) coupled with the managed VM and/or managed VM group. The VM LCM system monitors the lifecycle termination of a managed VM or a managed VM group, and completes a transaction settlement if the VM or VM group is coupled with transaction protocols (including the transaction protocols of its child objects). It may also track the whole lifecycle of a managed VM or a managed VM group and start the billing and tax procedure at billing points.

A managed VM's lifecycle may start after a VM transaction, a cloning of a managed VM, an installation of the first managed software, and/or a subscription of the first service. A managed VM group's lifecycle may start after a VM group transaction, a cloning of a managed VM group, a subscription of the first service, an adding the first managed child VM or VM group, and/or one of child VM or VM group turns to a managed VM/VM group. VM LCM system may receive relevant notifications from VM OPS monitor system to detect VM or VM group lifecycle start/termination, or VM LCM system may hook into VM and VM group operations; or users may be required to perform VM and VM group operations via VM LCM system.

A VM delivery service may accept a VM or a VM group delivery request from the trading system to deliver a VM or a VM group product to the buyer. In a clone transaction, a clone of the VM or a VM group may be made and transferred to the buyer. In a grant transaction, the VM or VM group may be transferred to the buyer. For a template product, the VM or a VM group template may be imported. When there is a transaction term definition in a grant transaction, a snapshot of the VM or VM group may be taken prior to the delivery.

VM LCM system checks the transaction bindings (including transaction protocols of child objects) of a VM or a VM group to validate a cloning operation, and maintains a cloning history of the managed VM or a managed VM group for the billing service for calculation of payment and profit sharing.

VM LCM system may keep accounts of an existence time of a managed VM or a managed VM group, and start the billing and tax procedure at billing points, if the VM or VM group transaction protocol includes an owning time involved payment schema.

VM LCM system may keep accounts of a powered-on time and frequency of a managed VM or a managed VM group, and start the billing and tax procedure at billing points, if the VM or VM group transaction protocol includes a usage involved payment schema.

VM LCM system may monitor a transaction term of a managed VM or a managed VM group, and trigger different actions as per the VM transaction protocol definitions. For a grant transaction, the VM or VM group may be restored to the snapshot taken before the transaction and returned back to the seller. For a clone transaction, the VM or VM group may be removed and/or lose the power-on right. A transaction term may be measured by VM or VM group existence time or powered-on time.

Software LCM may monitor the lifecycle start of managed software, add the software transaction protocol to the parent VM's transaction protocol bindings, and start the billing and tax procedure (if this is required by the software transaction protocol). Software LCM may monitor the lifecycle termination of managed software, complete transaction settlement, and remove the software transaction protocol from the parent VM's transaction protocol bindings. Software LCM may also track the whole lifecycle of managed software, and start the billing and tax procedure at billing points.

The lifecycle of managed software may start after a software installation (e.g. after a software transaction) or when a new software copy is made with the parent VM cloning. The lifecycle of managed software may terminate after software uninstallation, software transaction term expiration, and/or when the parent VM is removed, or when the software (with its parent VM) is transferred to another user.

A software installation service can handle software installation and uninstallation requests to install and uninstall the software to/from the parent VM. Managed software is allowed to be installed only through the software installation service. There may be many possible implementations of the installation service. The installation service registers installed software to a managed software list of the parent VM, so the software LCM system can check whether software is legally installed from the list. When managed software is uninstalled, it is removed from the parent VM's managed software list.

Software LCM system may be able to prevent illegal software copies. There may different implementations of this software copy control. Virtualization technologies (e.g. VMSafe™) may be leveraged, which may monitor program execution and processes in a guest system. A guest OS in the cloud may be limited to cloud aware (secure) OS that is able to control software installation and execution in a guest system, such that a guest OS is able to call to software LCM system to check if managed software or the guest OS itself is legally installed. Managed software may be cloud aware and the managed software may call to software LCM system at software program startup to check if it is legally installed, and may quit the execution if it is an illegal copy.

Software LCM system keeps accounts of existence (installation) time of managed software, and starts the billing and tax procedure at billing points, if the software transaction protocol includes an owning time involved payment schema.

Software LCM system may keep accounts of running time of managed software and frequency, and start the billing and tax procedure at billing points, if the software transaction protocol includes a usage involved payment schema. Software usage accounting may also be implemented in different ways. Virtualization technologies (e.g. VMSafe®) may be leveraged, which is able to monitor program execution in a guest system. A selection of a guest OS in the cloud is limited to a cloud-aware (secure) OS, such as one that is able to monitor a software program execution in a guest system and report managed software running time and frequency to software LCM system. Managed software may be cloud aware and call the software LCM system to report the running time and frequency of itself.

Software LCM system may monitor the transaction term of managed software, and uninstall the software or remove the software program execution right at term expiration. A transaction term may be measured by software existence (installation) time, software program running time, number of times of software program execution, or parent VM powered-on time.

Service LCM system may monitor the lifecycle start of a service, add the service transaction protocol to the parent VM or VM group's transaction protocol bindings, and start the billing and tax procedure (if this is required by the service transaction protocol). Service LCM system may monitor the lifecycle termination of a service, complete transaction settlement, and remove the service transaction protocol from the parent VM or VM group's transaction protocol bindings. Service LCM system may also track the whole lifecycle of a service, and start the billing and tax procedure at billing points.

The lifecycle of a service may start after a service subscription (e.g. after a service transaction) or when a new service copy is made with the parent VM or VM group cloning. The lifecycle of a service may terminate after service unsubscription, service transaction term expiration, when the parent VM or VM group is removed, or when the service is transferred (with its parent VM or VM group) to another user.

A service subscription service may handle service subscription and unsubscription requests to subscribe to or unsubscribe a service for the parent VM or VM group. A service may be allowed to be subscribed only through the service subscription service.

Service LCM system keeps accounts of a service's existence (subscription) time, and starts the billing and tax procedure at billing points, if the service transaction protocol includes an owning time involved payment schema.

Service LCM system keeps accounts of a service's serving time, and starts the billing and tax procedure at billing points, if the service transaction protocol includes a usage involved payment schema.

Service LCM system monitors the transaction term of a service, and unsubscribes the service at term expiration. A transaction term may be measured by service existence (subscription) time, service serving time, or parent VM or VM group powered-on time.

The disclosed software licensing and transaction model may be implemented in various different platforms and/or environments. Those skilled in the art upon reading the specification and studying the drawings will realize various implementations of the disclosure. For example, other platforms and/or environments may include a PaaS cloud, mobile platform, application container, trusted computer. The services and/or mechanisms disclosed may be incorporated in the implementation of the software licensing and transaction model.

In an embodiment where the platform is owned by an end user, the user may run an application on their own platform (e.g. mobile phone). A user buys an object (e.g. software program) from another user or a specific service provider based on a transaction protocol. The platform of the end user may be able to enforce the transaction protocol; the platform may be able to monitor object operations, control object rights, track object lifecycle, and keep accounts of object owning time and usage, while all those cannot be interfered by users. The platform may be trusted by a central server and/or trusted by another platform.

A transaction may be established through a central server. In another embodiment, the transaction is established through a platform and another platform (e.g., the buyer's platform and the seller's platform). The central server may also be used for product registration, production information storage and searching, trading, transaction protocol recording, billing and tax, user management, etc.

FIG. 2 further illustrates various services in an IaaS cloud environment disclosed herein. In one or more embodiments, one or more users, for example, a software vender 108₁, a VM vender 108₂, a consumer 108₃, and a service provider 108₄ access the cloud and the user management system 202 manages the users. In one or more embodiments, the users is allowed to publish an object (e.g., software, service, VM, VM group, and the like) with a publication system 210 of a cloud.

For example, the software vendor 108₁ may register software, the VM vender or solution integrator or distributor 108₂ may register a VM or VM group, and the service provider 108₄ may register a service. In one or more embodiments, the users predefine one or more transaction protocols during the registration. Further, in one or more embodiments, the consumer 108₃ queries the publication system 210 for desired software and finds the desired software through a query service of the publication system 210. In one or more embodiments, the consumer 108₃ may submit a software transaction request for the desired software to the trading system 212 of the cloud. Following the submission, the consumer 108₃ may start a transaction protocol negotiation with the software vender 108₁ on the trading system 212.

Further, the consumer 108₃ and the software vender 108₁ reach an agreement, and pass the final transaction protocol to the transaction validation service. In one or more embodiments, the transaction validation service may check the transaction protocol, and may request a rights management system 220 to check rights of a target VM. Further, following the check, the transaction validates and a software installation request is sent to the software LCM 224. A software installation service installs the software to the target VM, and adds the software transaction protocol to the target VM's transaction protocol bindings.

Similarly, in a service transaction, a service subscription request may be sent to the service LCM 226, and in VM or VM group transaction, a VM or VM group delivery request may be sent to the VM LCM 228. A subscription service of the service LCM 226 may allow the consumer 108₃ to subscribe to a service for a VM or VM group, and add the service transaction protocol to the target VM or VM group's transaction protocol bindings. A delivery service of the VM LCM 228 may allow the consumer 108₃ to utilize the VM or VM group, and generate the VM or VM group's transaction bindings.

A billing and tax system 214 may be notified by the software LCM 224, the service LCM 226, and the VM LCM 228 to bill the consumer 108₃, after the software transaction, the service transaction, and the VM or VM group transaction respectively. Further, a transaction billing service may then notify a transaction tax service to levy transaction tax on the software vendor 108₁, the service provider 108₄, and the VM vender or solution integrator or distributor 108₂ respectively.

Further, a running time accounting service of the software LCM 224 may start to count an installed time, a running time and frequency of the software. A working time accounting service of the VM LCM 228 starts to count an existence time and a powered-on time of the VM or VM group. A serving time accounting service of the service LCM 226 starts to count a subscribed time and a serving time of the service. Each of the software running time accounting service, the working time accounting service, and the serving time accounting service, then notifies a billing and tax system 214 at one or more billing points. Furthermore, a transaction term monitoring service within each of the software LCM 224, the service LCM 226, and the VM LCM 228 starts to detect a transaction term expiration of the software, the service, and the VM or VM group respectively, and triggers relevant actions at term expiration.

The VM OPS monitor system 222 may monitor the VM or VM group objects and events, and notify the rights management system 220, software LCM system 224, the service LCM system 226, and the VM LCM system 228.

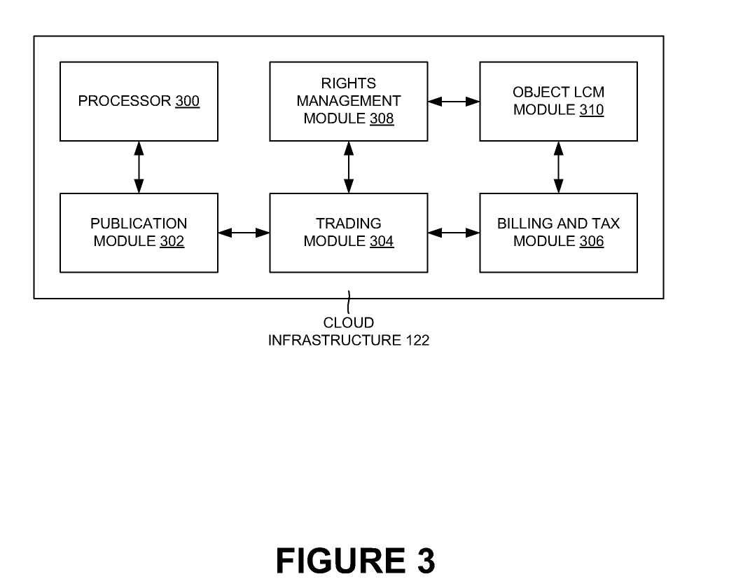

FIG. 3 is a schematic view of a cloud infrastructure 122 of a cloud environment 120, according to one or more embodiments. In one or more embodiments, the cloud infrastructure 122 includes a processor 300, a publication module 302, a trading module 304, a billing and tax module 306, a rights management module 308, an operation monitoring module 312, and an object lifecycle management module 310. The processor 300 may control and coordinate functioning of the publication module 302, the trading module 304, the billing and tax module 306, the rights management module 308, the operation monitoring module 312, and the object lifecycle management module 310. The publication module 302 is configured to control publication of an object within the cloud environment 120. The trading module 304 is configured to control a transaction performed using the object 120 in the cloud environment 120. The billing and tax module 306 may be configured to control billing transactions performed using the object 102. Further, the billing and tax module 306 also may be configured to levy tax on one or more users (distributors) of the object 102 in the cloud environment 120. The rights management module 308 is configured to control and check rights of using or performing a transaction with the object 102. The operation monitoring module 312 is configured to monitor the operations on the object 102. The object lifecycle management module 310 is configured to monitor the lifecycle of the object 102 in the cloud environment 120.

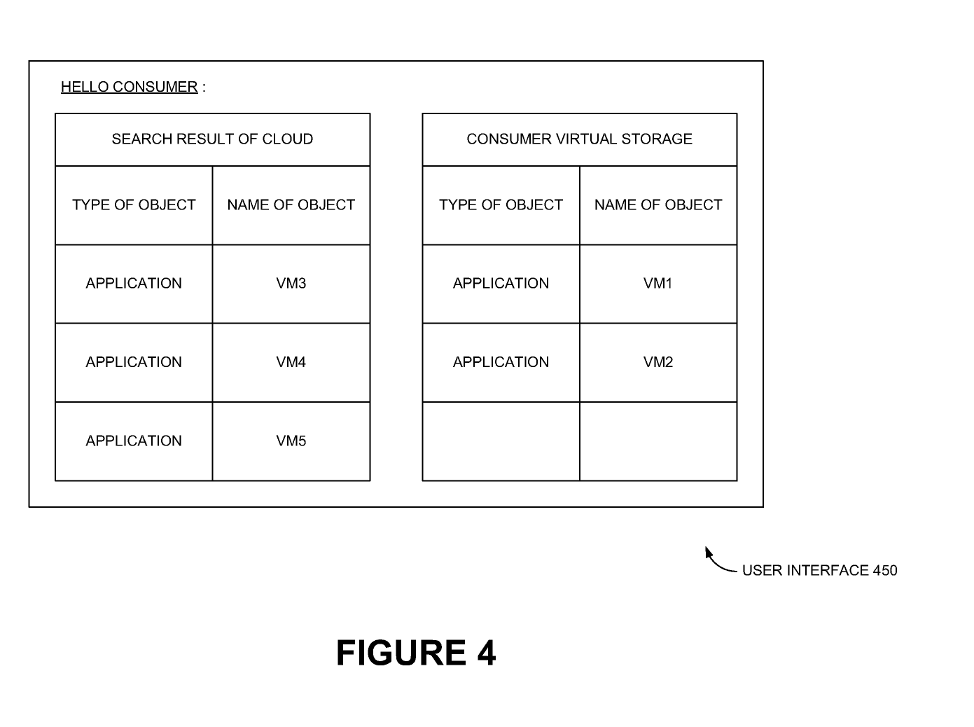

FIG. 4 is a schematic view of a user interface 450 of the cloud environment 120 of FIG. 1, according to one or more embodiments. In one or more embodiments, the user interface 450 displays a selection result window. The selection result window may display a search result based on the type of the object 102 and/or the name and other characteristics of the object. The type the object 102 may include, but is not limited to an application, an application group, an application component, and a service. A user 108 may limit the search to a specific type of object 102. The search may be limited to applications.

In one or more embodiments, the user interface 450 displays a consumer 108₃ virtual home window. The consumer virtual home window displays the objects 102 that the consumer 108₃ owns. The objects 102 that the consumer 108₃ owns are displayed by the type of the object 102 and the name of the object 102. The virtual home window provides an interface for the user to access and an environment (with resources) to store and run objects.

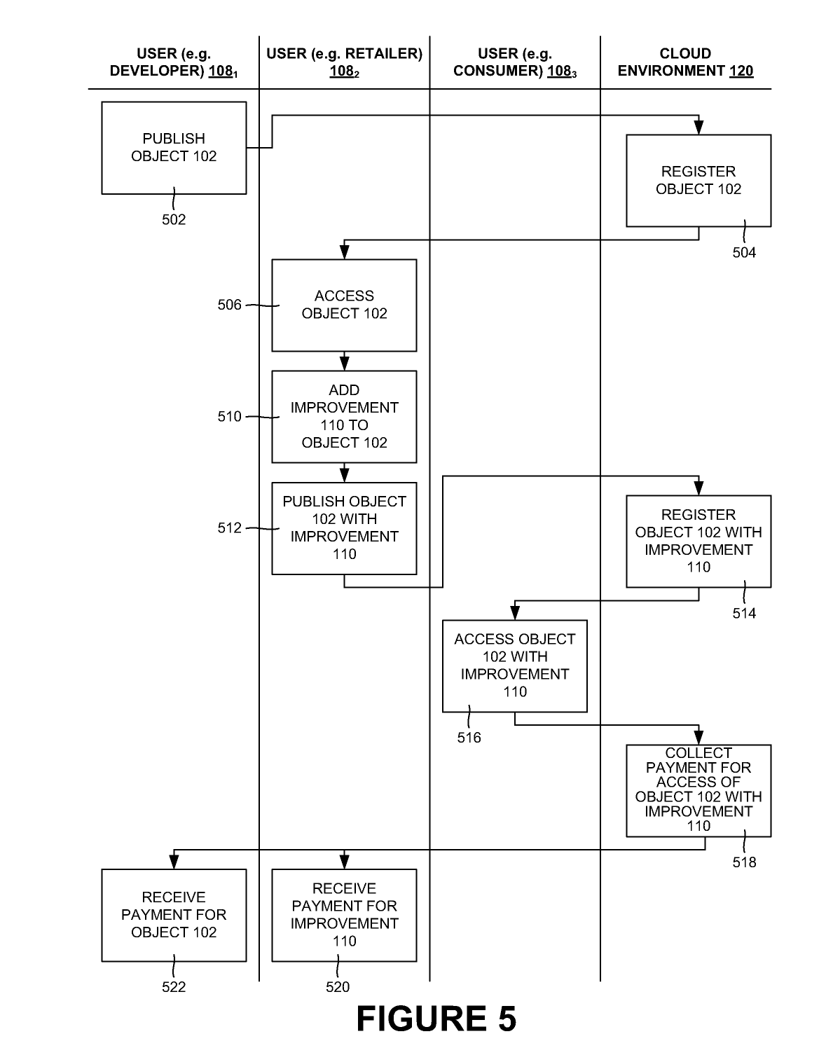

FIG. 5 is a path flow diagram illustrating the operations of the users in the system of FIG. 1, according to one or more embodiments. In operation 502, an object 102 may be published in a cloud environment 120 by a first user (e.g., a developer) 108₁. In operation 504, the object 102 may be registered in the cloud environment 120 to be a product. In operation 506, the object 102 may be purchased by a second user (e.g., a retailer) 108₂. In operation 508, the second user 108₂ may add an improvement 110 to the object 102. In operation 510, an object 102 with improvement 110 may be published in a cloud environment 120 by a second user (e.g., a retailer) 108₂. In operation 512, the object 102 may be registered in the cloud environment 120 with the improvement 110. In operation 514, the object 102 with the improvement 110 may be purchased by a third user (e.g., a consumer) 108₃. In operation 516, a payment may be collected from the third user (e.g., a consumer) 108₃ of the cloud environment 120 for accessing the object 102 with improvement. In operation 518, a second user (e.g., a retailer) 108₂ may receive a share of a profit from the payment for improvement 110. In operation 520, a first user (e.g., a developer) 108₁ may receive a share of the profit from the payment for publishing the objet 102 to the cloud environment 120.

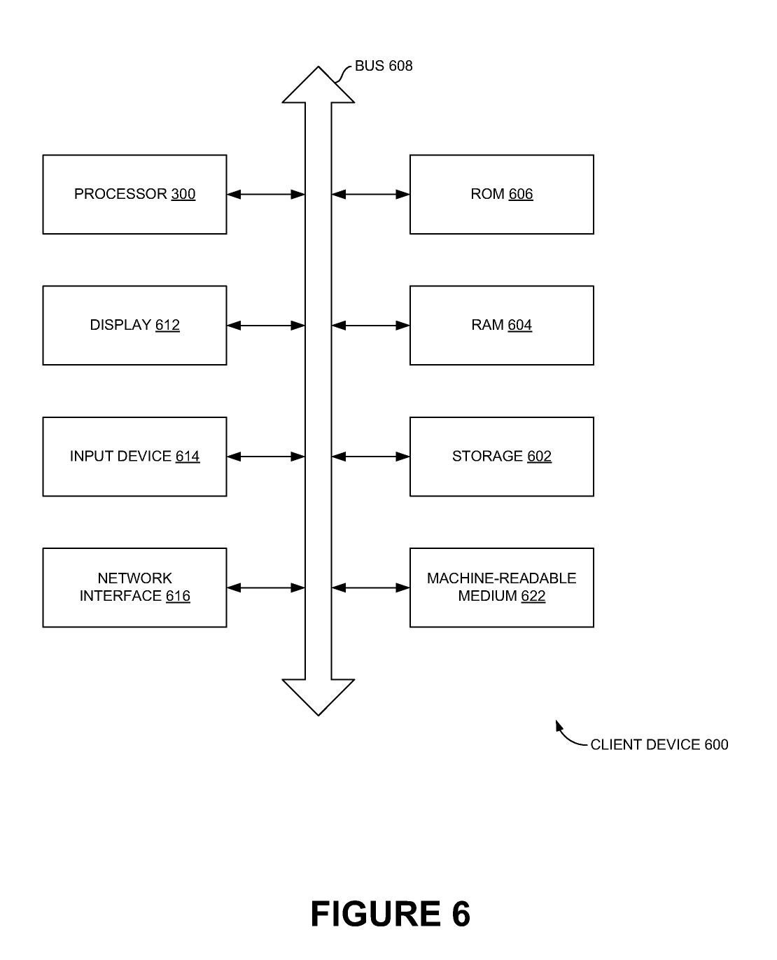

FIG. 6 is a schematic view of a client device 600, in accordance with one or more embodiments. The platform may be accessed through the client device 600. The client device may be used to access the user interface 450 and/or an object (e.g., virtual machine (VM)) in the cloud. Examples of the client device include, but are not limited to, a portable electronic device, a communication device, a laptop, a desktop, and the like. In one or more embodiments, the client device 104 includes a processor 300 operatively coupled with a bus 608. The processor 300 controls and processes various functionalities of the client device 600. In one or more embodiments, the processor 300 is operatively coupled with a monitoring module. The monitoring module may be configured to monitor the utilization of an object in the cloud environment 120, through the client device 600.

Further, the client device 600 may also include a memory such as a random access memory (RAM) 604 or other storage 602 such as dynamic storage device, coupled to the bus 608 for storing information which can be used by the processor 300. The storage 604 may include, for example, a flash drive, a pen drive, a hard disk or any other storage media. The memory can be used for storing any temporary information required, for example, the software running time, working time of a VM, and the like. The client device 600 further includes a read only memory (ROM) 606 or other static storage device coupled to the bus 608 for storing static information for the processor 300. The client device 104 can be coupled via the bus 608 to a display 612, Examples of the display include, but is not limited to a cathode ray tube (CRT), a liquid crystal display (LCD) or a light emitting diode (LED) display for rendering the display to one or more users of the client device 600. An input device 614 including alphanumeric and other devices, may be coupled to the bus 608 for communicating an input to the processor 300.

Another type of input device 614 may be a cursor control, such as a mouse, a trackball, or cursor direction keys for communicating the input to the processor 300 and for controlling cursor movement on the display 612. The input device 614 may also be included in the display 612, for example a touch screen. In some embodiments the client device may coupled via the bus 610 to a network interface 616. Various embodiments are related to the use of the client device 104 for implementing the techniques described herein. In one or more embodiments, the techniques are performed by the processor 300 using information included in the memory. In one or more embodiments, the information is read into the memory from a machine-readable medium 622. The term “machine-readable medium” as used herein may refer to any medium that participates in providing data that causes a machine to operate in a specific fashion. In one or more embodiments implemented through the client device 600, various machine-readable medium are involved, for example, in providing information to the processor 300.

The machine-readable medium 622 may be a storage media. Storage media includes both non-volatile media and volatile media. Non-volatile media includes, for example, optical or magnetic disks, such as the storage unit. Volatile media includes dynamic memory, such as the memory. All such media must be tangible to enable the information carried by the media to be detected by a physical mechanism that reads the information into a machine. Common forms of machine-readable medium 622 include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge. In another embodiment, the machine-readable medium can be a transmission media including coaxial cables, copper wire and fiber optics, including the wires that include the bus 610. Transmission media can also take the form of acoustic or light waves, such as those generated during radio-wave and infra-red data communications.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Protocols such as SOAP/HTTP may be used in implementing interfaces between programming modules. As would be known to those skilled in the art the components and functionality described above and elsewhere herein may be implemented on any desktop operating system such as different versions of Microsoft Windows, Apple Mac, Unix/X-Windows, Linux, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network. One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion. While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

1. A method of a server device comprising:
publishing availability of an object of a user such that the object is searchable by another user through a user interface;
enabling transacting between the user and the another user, the transacting being specific to access of the object by the another user;
determining a transaction protocol that defines a transaction between the user and the another user, the transaction protocol including a scope of access to the object by the another user;
determining a sum of money to collect from the another user based on a payment scheme, wherein the payment scheme is based on the transaction protocol; and
monitoring the access of the object by the another user such that the access to the object is restricted to the scope of access defined in the transaction protocol, such that piracy of the object is controlled through a management of the access of the object by the another user.

2. The method of claim 1:
wherein the object is stored and runs on a platform;
wherein the object is one of an application, an application group, an application component, and a service; and
wherein the platform is one at least of a hypervisor, an application container, a mobile platform, and a computer comprising a trusted operating system.

3. The method of claim 1 further comprising:
coupling the transaction protocol to the object such that the object comprising the transaction protocol is controllable based on the transaction protocol; and
preventing the user from modifying the transaction protocol coupled with the object.

4. The method of claim 2 further comprising providing the platform through a cloud environment, wherein the cloud environment is one at least of a platform as a service cloud and an infrastructure as a service cloud.

5. The method of claim 4:
wherein the application is a virtual machine;
wherein the application group is a virtual machine group;
wherein the application component is one of a guest operating system and an application software that is installed into the virtual machine; and
wherein the service serves and is subscribed by one of the virtual machine and the virtual machine group.

6. The method of claim 1 wherein the transaction is one of a clone transaction and a grant transaction of one of an application, an application group, an application component transaction, and a service transaction.

7. The method of claim 1 wherein the transaction protocol comprises one of the payment scheme, a term, and a set of object rights.

8. The method of claim 7 wherein the payment scheme includes at least one of a fixed payment, an object copy payment, an object usage payment, and an object owning time payment.

9. The method of claim 8 wherein the payment scheme is based on a tiered distribution model such that the another user that distributes the object to yet another user shares in a profit of a sale of the object and a copy of the object.

10. The method of claim 1 further comprising:
enforcing a right to use and access to the object based on the transaction protocol;
enforcing the right through a hypervisor;
enforcing the right through an operating system of a guest, wherein the operating system of the guest is aware of employment of a cloud environment; and
enforcing the right by the object, wherein the object is aware of the cloud environment.

11. The method of claim 10 further comprising preventing the user from participating in the transaction based on a limitation that restricts participation based on a certification.

12. The method of claim 1 further comprising:
validating the transaction based on a verification of the transaction protocol; and
comparing another transaction protocol of another object, wherein the another object is a descendant object of the object, such that the another transaction protocol of the another object is compatible with the transaction protocol of the object.

13. The method of claim 12 further comprising:
monitoring an object operation; and
controlling the object operation such that the object operation is in compliance with the transaction protocol coupled with the object.

14. The method of claim 1 further comprising:
managing a lifecycle of the object such that the management of the lifecycle is based on the transaction protocol;
starting one of a billing procedure and a tax procedure based on the transaction protocol;
managing an object lifecycle through the hypervisor;
managing the object lifecycle through the operating system of a guest, wherein the operating system of the guest is aware of the cloud environment; and
managing the object lifecycle through the object, wherein the object is aware of operation of a cloud environment.

15. The method of claim 14 further comprising:
monitoring an object lifecycle start and coupling the transaction protocol to the object;
monitoring an object lifecycle termination and settling the transaction;
keeping an account of the object owning time and an object usage;
monitoring a transaction term expiration of the object;
triggering a corresponding action at term expiration based on the transaction protocol of the object;
maintaining a cloning history of the application and an application group object; and
starting a billing and tax procedure at a billing point.

16. The method of claim 14 further comprising:
delivering the object after the transaction; and
preventing an illegal object copying.

17. The method of claim 16 further comprising:
dynamically calculating a payment based on the transaction protocol of the object;
collecting the payment based on the transaction protocol of the object; and
levying a transaction tax on a seller.

18. The method of claim 17 further comprising:
ranking the object based on a credit and a referral of a publisher, a frequency and a number of transactions for the object, a total number of copies made, a total time the object is in use, an average time an object copy is in use, a cost to use the object including the payment and a resource usage cost, a rating by users that have used the object, and a result of an object specific evaluation.

19. The method of claim 1 in a form of a machine-readable medium embodying a set of instructions that, when executed by a machine, cause the machine to perform the method of claim 1.

20. A method of a server device comprising:
enabling a publication of an object such that the object is searchable through a user interface by another user;
enabling transacting between the user and the another user, the transacting being specific to access of the object by the another user;
determining a transaction protocol that defines a transaction between the user and the another user, the transaction protocol including a scope of access to the object by the another user;
determining a sum of money to collect from the another user based on a payment scheme, wherein the payment scheme is based on the transaction protocol; and
enabling a distribution of the object such that the object of the user is available to the another user.

21. The method of claim 20 wherein:
the object is one of an application, an application group, an application component, and a service.

22. A system comprising:
an object;
a platform to store and run the object;
a processor to process a transaction of the object;
a transaction protocol to determine a scope of access of the object; and
a payment scheme based on the transaction protocol to determine a sum of money to collect through the transaction.

23. The system of claim 22 wherein the object is one of an application, an application group, an application component, and a service.
